(19) United States
(12) Patent Application Publication
(10) Pub. No.: US 2009/0157431 A1
(43) Pub. Date: Jun. 18, 2009

(54) PACKAGING OF BLINDED PATIENT DATA

(76) Inventor: Lisa Fournier, Lexington, KY (US)

Correspondence Address: ST. ONGE STEWARD JOHNSTON & REENS, LLC, 986 BEDFORD STREET, STAMFORD, CT, 06905-5619, US

(21) Appl. No.: 12/325,795

(22) Filed: Dec. 1, 2008

Related U.S. Application Data
(60) Provisional application No. 60/991,027, filed on Nov. 29, 2007.

(51) Int. Cl. G06Q 50/00; G06Q 10/00

(52) U.S. Cl. 705/3

(57) ABSTRACT

An apparatus having encoded instructions in a computer hardware circuit which combine digital data templates with patient digital data of selected patients from medical practice electronic health records to provide digital data packages in which patient digital data is mapped to data fields in the digital data packages. The digital data packages have a structure and format defined by the digital data templates. The patient digital data comprises one or more of blinded patient data and non-blinded patient data.

### CROSS-REFERENCE TO RELATED APPLICATIONS

The present application claims the benefit under 35 U.S.C. §119(e) of the U.S. Provisional Patent Application Ser. No. 60/991,027, filed on Nov. 29, 2007, the content of which is incorporated herein by reference.

### FIELD OF THE INVENTION

The invention relates to the electronic record keeping and distribution systems, and more specifically to a system and method for organizing and packaging medical and practice information for promotion and sale.

### BACKGROUND OF THE INVENTION

A patient's medical records contain a wealth of information useful for the research community. For example, each medical record generally contains detailed information such as symptoms of particular illnesses and the effectiveness of treatments which may not otherwise be accessible to physicians or researchers. Having access to such information could be invaluable in the search for new treatments and cures for many illnesses. Further, access to such data would provide physicians with an abundance real life data for use in evaluating treatment options for their patients. U.S. Pat. No. 7,438,233 and U.S. patent application Ser. No. 12/255,443, the disclosures of which are incorporated herein by reference, describe a system and method for transferring, maintaining and updating sensitive data, such as electronic medical or health records, and for blinding medical records to allow for the clinical use of anonymous medical information, such as for blinded research queries, while maintaining compliance with the HIPAA regulations regarding confidentiality of patient records. However, it is further desired to provide a means to package, organize, and promote blinded patient data and other medical and practice information for sale in a digital marketplace.

### SUMMARY OF THE INVENTION

The present invention comprises a system and method for packaging blinded patient data, medical and/or practice information for distribution and sale. The present invention provides templates and packaging tools and methods for use in a digital marketplace.

### BRIEF DESCRIPTION OF THE DRAWINGS

FIG. 1 illustrates a research network integrated with a digital marketplace providing a system in which the present invention is used.

FIG. 2 illustrates a flow chart for packaging data according to an exemplary embodiment of the present.

### DESCRIPTION OF THE INVENTION

The present invention will preferably be used in a digital marketplace for healthcare data as described in “Digital Marketplace for Healthcare Data”, U.S. Provisional Patent Application Ser. No. 60/991,022, filed on Nov. 29, 2007, and in the application entitled “Digital Marketplace for Healthcare Data” filed Dec. 1, 2008 with a claim of priority under 35 U.S.C. §119(e) to U.S. Provisional Patent Application Ser. No. 60/991,022, the disclosures of which are hereby incorporated by reference.

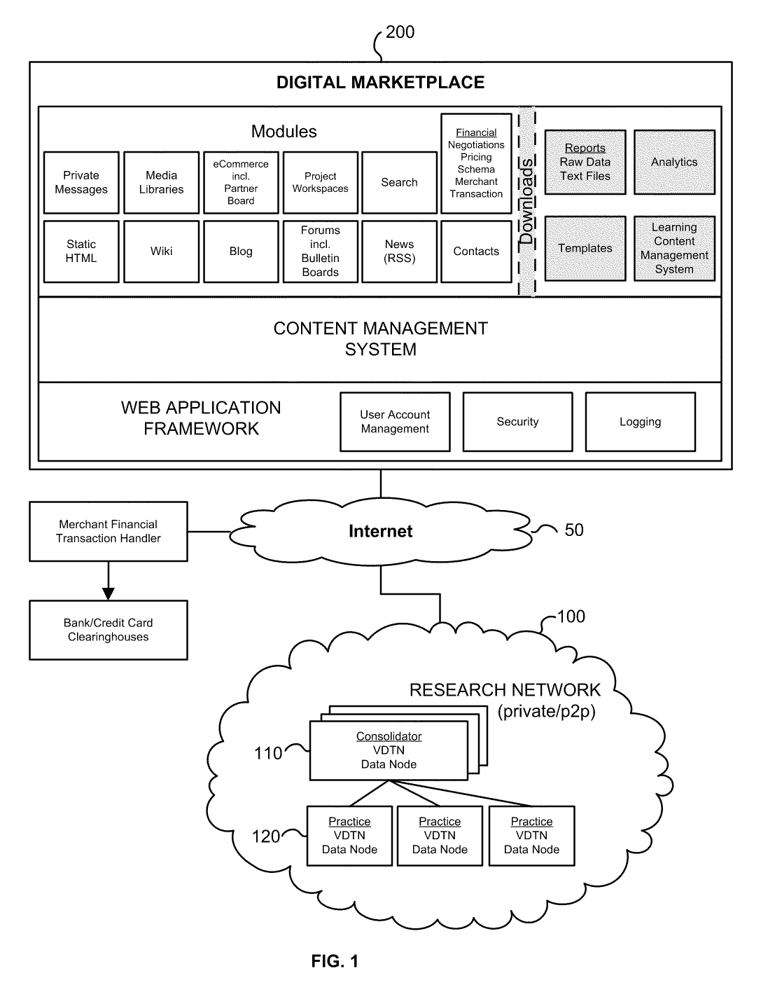

The digital marketplace 200 for healthcare data system is connected by the Internet 50 to a research network 100 as illustrated in FIG. 1. The research network is a peer-to-peer (“P2P”) data processing network including any number of “peers” or data nodes, including consolidator data nodes 110 and medical practice data nodes 120. In a preferred embodiment, each data node is a data processing system which is operating peer software. For example, a practice data node may include peer software loaded on the practice's server and accessible by practice users at a plurality of workstations. The peer software includes software for accessing a virtual data transformation node (“VDTN”) of the system (e.g., VDTN client software). The practice data nodes hold the patient data and practice data of the network and respond to requests for transfer of that data. The present invention contemplates that the different practice nodes will have Electronic Health Record (EHR) software from many different possible vendors, each with a different underlying data structure and field names.

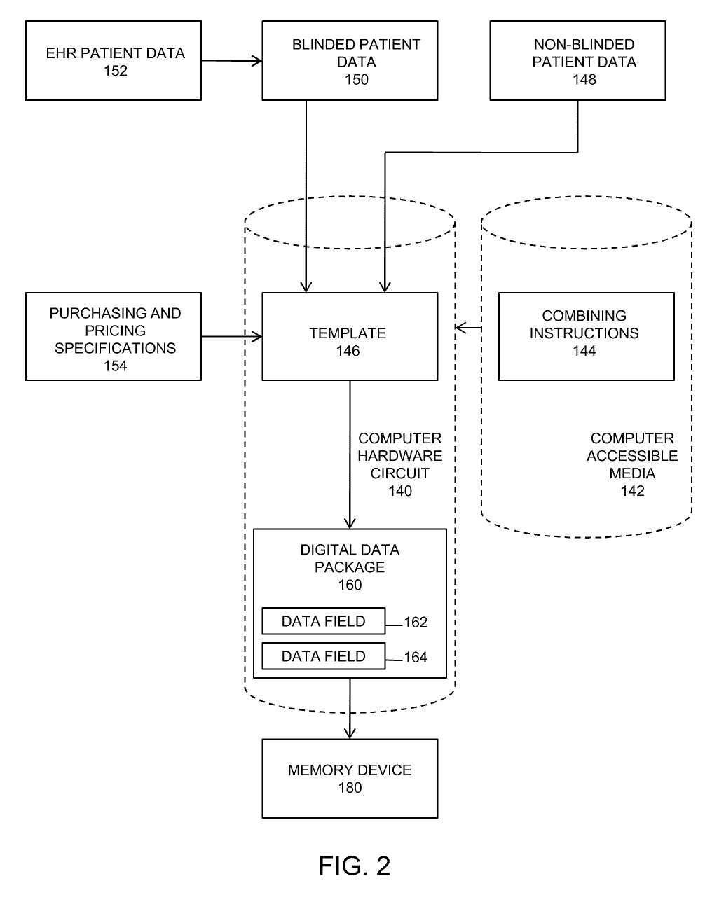

The present invention particularly is illustrated in FIG. 2 and is directed at an apparatus comprising: a computer accessible medium 142 associated with a computer hardware circuit 140, which medium 142 is encoded with a plurality of instructions 144 that when executed in the computer hardware circuit combine one or more digital data templates 146 with patient digital data 148, 150 of one or more selected patients from one or more medical practice electronic health records 152 to provide one or more digital data packages 160 in which patient digital data is mapped to n number of data fields 162, 164 in the digital data packages. The digital data packages 160 have a structure and format defined by the digital data templates 146. The digital data packages 160 are stored in a memory device 180. The patient digital data 148, 150 comprises one or more of blinded patient data 150 and non-blinded patient data 152 as further described hereafter. The patient digital data preferably comprises one or more of patient digital data patient age, height, weight, blood pressure, lipid profile, past medical history, symptoms, diagnostic procedure, diagnosis, treatment, prescription, intervention, and outcome of treatment, and optionally additionally can include one or more of laboratory data, social and family history, education, risks, assessment and plan, patient diary data, etc. This list is not exhaustive and the patient digital data may include any number of other data fields that are accessible. Preferably, there are also a plurality of instructions which, when executed in the computer hardware circuit, combines the one or more digital data templates with one or more of purchase and pricing specifications 154 which are mapped to data fields in the digital data packages 160. A related system and method are also encompassed by the invention.

A template 146 in accordance with the present invention is a data processing structure that can be combined with patient data and/or practice data and processed by a template engine (the combining instructions 144) in the data processing system to produce a data package 160 that is offered for sale in the digital marketplace for healthcare data as a “ware.” The template 146 can be an XML document or a different data structure. Templates 146 according to the present invention provide a standard structure and format for the ware that is created from unstructured content from practice nodes 120 having different EHR data structures 152. Templates provide a standard set of features, procedures, or visual presentation to a system user. Data sellers and data purchasers can leverage templates to automate certain processes or to format data or content in a standardized way.

Templates 146 desirably have data importing modules that are specifically adapted to different commercially available EHR systems and/or the EHR systems are modified to provide them with data exporting modules that export data as called for by the templates.

Templates 146 can also guide data sellers through a process such data blinding, and can guide data sellers and purchasers through processes such as analytics, presentation, packaging, or reports.

In the preferred embodiment, the practice data nodes 120 generate a data package 160 by applying a template 146 using a computer hardware circuit 140 associated with the practice node 120, transforming raw data into a data package 160 that is a ware that can be bought or sold on the Digital Marketplace 200 or otherwise acted on in the research network 100. The template 146 may extract blind data, join one or more raw data sets together (such as patient data combined with practice data), create raw data tables, create data analyses, summaries and other processed data tables. The template 146 can also embed ware purchase or pricing specifications such as royalties, price per record, and licensing information in the ware. In a preferred embodiment, the template 146 operating at the practice data node dynamically assembles the data package elements into the ware when a purchase transaction occurs.

Wares may also include a collection of related information or data that makes up an item for sale and/or any digital media file (raw data, audio, video, document, etc.) that a content seller has rights to sell (i.e., white papers, e-learning objects, best practices, etc.). A set of users may collaborate in creating or modifying wares. For example, a user or multiple users may (1) collect blinded medical data, (2) analyze the medical data, (3) compose a journal article, (4) micro-publish the article, analysis and associated medical data, then (5) sell the published ware in the digital marketplace system. A set of users could then be selected to (6) peer-review the work and add their comments to the published work. Royalties are paid to each of the members who contributed in the project workspace (those who gave data, those who analyzed the data, those who did the write-up). If the article leads to some new technique or break-through, (7) an eLearning package could be created based on the work of the article. A template 146 may define, structure and/or incorporate any of these different data fields and it may even compose a journal article or an eLearning package from unstructured data and the other content.

It should be noted that patient data and practice data comes in two electronic formats: “non-blinded” and “blinded.” Non-blinded data 148 is authorized patient information that is shared in and among the medical community. Blinded data 150 is patient and practice information that is processed to remove any patient-identifying information. In most cases, the system and method of the invention will be used to package blinded patient data 150 medical and/or practice information for distribution and sale, however, in some instances there may be non-blinded patient or practice data 148 that has been authorized by the patient to be publicly disclosed in the system without restrictions on patient identification. In either case, the template 146 may only operate on non-blinded data 148 and/or blinded data 150, or other authorized data, and may not incorporate confidential patient EHR data 152.

In alternative embodiments, the data packages 160 are generated by templates 146 provided in s server such as an intermediary computer data processing system operating between the practice node 120 and a data purchaser, or they may be generated by templates 146 provided in a computer data processing system associated with the data purchaser.

The process of packaging data in according to the inventions may be implemented by machine when a request for particular data types is received, or a practice may choose to create data packages using available data prior to receipt of a specific request.

One possible embodiment of the present invention applicable where a practice chooses to create a data package in advance may involve the following steps. The system asks the content creator which template they want to use to package the digital product. The content creator selects a packaging template, and the system “runs” the template. This may consist of a set of interview-type questions or simple prompts for files to upload or media library files to include. The content creator provides whatever information is required by the template. This will include metadata. The content creator clicks submit, and the system executes any post-process packaging logic and adds the package to the research network. The package is shown to the user on a screen such as My Account and/or My Digital Product Packages. The content creator may delete and edit packages. Content sellers (i.e.: physicians, 3rd-party content providers, etc.) may therefore upload, manage, package and sell their wares via the ecommerce component of the digital marketplace system. The completed data packages (wares) can be electronically transferred to a data requester by a download protocol from the practice to a requester using the research network and the ecommerce component of the digital marketplace system as the facilitator and conduit for payment processing.

One possible embodiment of the present invention applicable where a machine implemented process is triggered in response to a request for particular data types described below. The following example describes the steps of a research inquiry using systems automatically inventing the invention:
1. A clinical researcher (CR) receives a research study request.
2. The CR logs into the research network and queries various criteria to determine the types and quantity of data available (i.e.: patients over 35 years old with hypertension and diabetes; patients over 35 with obesity and diabetes.)
3. The CR enters the query into the research network to broadcast a search inquiry to the network of credentialed practitioners (doctors, hospitals, etc.).
4. The system alerts participating practitioners to the data request and the amount of data currently in the practitioner's database that meets the search criteria.
5. The practitioner may negotiate data package content, volume, and price if so desired.
6. A data package is created by packaging together the requested data in a standard template format;
7. The data package, with optional purchase or pricing specifications such as royalties, price per record, and licensing information is ready for delivery and is and delivered to the requestor as a ware.

The practitioner can increase the size of its data package or ware, and therefore its value, by asking selected patients very specific requests through a patient communication channel such as a website or email inquiry. For instance, if a research inquiry sought hypertension patients that were experiencing sweats on a nightly basis. The physician could gather that data by sending an email to his practice's patients having the condition, and/or by adding that data field to the practices electronic heath record (“EHR”) software to start aggregating that specific data point.

Other data fields that might exist or be added in a practice node EHR system, and its related template, and resulting data package, include: patient age, height, weight, blood pressure, lipid profile, past medical history, symptoms, diagnostic procedure(s), diagnosis, treatment(s) and prescription(s) and intervention(s), outcome(s) of treatment. Other specific data fields will include laboratory data, social and family history, education, risks, assessment and plan, patient diary of his condition, etc.

The practitioner can also increase the size of the data package, and therefore its value, by partnering up with another practice or other data source to provide a combined data package. Data can be aggregated from current data in the practitioner's database, data from another practitioner; as well as the above discussed additional data from the patient.

Typical basic data fields associated with a data package created by a template may include the following data fields. In the following list, the data field name is followed by a description of the data field.

### DataPackage_ID

primary key

### DataPackageType_ID

foreign key to DataPackagesType table

### Query_ID

foreign key to Queries table. Represents the query that was executed to generate this data package

### Practice_ID

foreign key to Practices table. Represents the practice from which this data was generated

### User_ID

foreign key to Users table. Represents the user for which this data package was prepared. NOTE: this may not be the same user that composed the query. This will occur when a user decides to reuse another user's query.

### Results

result data. May be stored in encrypted format

### ResultsDateTime

the date time when the results were generated

### Title

a brief description of the data package. This may be auto generated based on summary information following a defined template

### Description

a longer description of the data package. This may be auto generated based on summary or results data following a defined template

The data package is a data structure that contains record data in a specific way. In one preferred embodiment, the data package is an XML document. The data package contains x number of records and each record contains y number of field name:field value pairs.

An associated report builder can be used to export data to a report format. The report builder will typically accept three data package formats:
1. “Type A” is object[ ] where each element in the array is a Dictionary<string, string>.
2. “Type B” is List<object> where each item in the list is a Dictionary<string, string>.
3. “Type C” is an XML document in the appropriate format.

With each type, an entry in the Dictionary<string, string> represents the same thing: a field name and a field value. A Dictionary is a collection of items not unlike a hash table. The generic declaration is Dictionary<key, value> and to access the dictionary by its key returns the associated value. With the report builder data package, each Dictionary<key, value> represents one field name:field value pair. The entire dictionary represents all of the fields for one given record.
An entry in Dictionary<key, value> deconstructs to key=field name and value=field value.
In the case of the report builder, Dictionary<string, string> an example field name, value pair might be: key=“Age” and value=“43”

In one embodiment, it is assumed that each dictionary represents a patient and that the entries in the dictionary are field name:field value pairs that define data elements which describe the patient.

The described data package format is extensible to handle records of multiple types. In one embodiment, the report builder builds each dictionary, which represents one record, with an entry where the key is “PatientId” and the value is the int primary key from the table holding patient data. The Report Builder filters the int data out of text reports, but uses it as the root element of a record in xml reports, e.g.,

XML Report

<?xml version=“1.0” encoding=“UTF-8”?>
<report>

<patient id=“2416”>

<HomeState>

<data>KY</data>

</HomeState>
<Gender>

<data>male</data>

</Gender>

</patient>
<patient id=“2419”>

<HomeState>

<data>KY</data>

</HomeState>
<Gender>

<data>male</data>

</Gender>

</patient>

</report>

and the corresponding text report:

Text Report

HomeState = KY
Gender = male
HomeState = KY
Gender = male

The data package template scheme can be extended by specifying more “special” entries in the dictionary. “PatientId” (in any combination of upper and lower case letters) is the only special dictionary entry. It defines what the entire dictionary represents as one record.

Alternatively, a generic entry such as key=“RecordType” and value=“RecordName” can be selected. This entry would be, key=“RecordType” and value=“PatientId”. The value associated with the key PatientId can be omitted (“ ”) in report builder, but report builder does expect the key to be present for the data package to be considered correctly formatted.

Other data fields may be developed and implemented as required by a person of ordinary skill in the art.

What is claimed is:

1. An apparatus comprising: a computer accessible medium associated with a computer hardware circuit, said medium being encoded with a plurality of instructions that when executed in the computer hardware circuit combine one or more digital data templates with patient digital data of one or more selected patients from one or more medical practice electronic health records to provide one or more digital data packages in which patient digital data is mapped to data fields in the digital data packages, the digital data packages having a structure and format defined by said digital data templates; the digital data packages being stored in a memory device.

2. The apparatus of claim 1, wherein the patient digital data comprises one or more of blinded patient data and non-blinded patient data.

3. The apparatus of claim 2, wherein the patient digital data comprises one or more of patient digital data patient age, height, weight, blood pressure, lipid profile, past medical history, symptoms, diagnostic procedure, diagnosis, treatment, prescription, intervention, and outcome of treatment.

4. The apparatus of claim 3, wherein the patient digital data further comprises one or more of laboratory data, social and family history, education, risks, assessment and plan, and patient diary data.

5. The apparatus of claim 1, further comprising a plurality of instructions which, when executed in the computer hardware circuit, combines the one or more digital data templates with one or more of purchase and pricing specifications which are mapped to data fields in the digital data packages.

6. The apparatus of claim 1, wherein said computer hardware circuit is associated with a practice node.

7. The apparatus of claim 1, wherein said computer hardware circuit is not associated with a practice node.

8. A system for facilitating commercial exchange of packages of electronic health records, comprising:
a plurality of practice nodes in communication with a server, each practice node having a plurality of electronic medical records;
software executing on the server for receiving a request from a requester for at least a portion of the electronic medical records; and
software executing on said practice nodes for blinding the electronic medical records and transferring blinded patient digital data omitting patient identification data to a computer hardware memory circuit;
software executing on said practice nodes or said server for combining one or more digital data templates with the blinded patient digital data in the computer hardware memory circuit to provide one or more digital data packages in the which blinded patient digital data is mapped to data fields in the digital data packages, the digital data packages having a structure and format defined by said digital data templates;
software executing on said practice nodes or said server for electronically transferring the one or more digital data packages to the requester.

9. The system of claim 8, wherein the software executing on said practice nodes or said server for combining one or more digital data templates with the blinded patient digital data also combines said templates with non-blinded patient data.

10. The system of claim 8, wherein the blinded patient digital data comprises one or more of patient digital data patient age, height, weight, blood pressure, lipid profile, past medical history, symptoms, diagnostic procedure, diagnosis, treatment, prescription, intervention, and outcome of treatment.

11. The system of claim 10, wherein the blinded patient digital data further comprises one or more of laboratory data, social and family history, education, risks, assessment and plan, and patient diary data.

12. The system of claim 8, wherein the digital data templates further comprise one or more of purchase and pricing specifications which are mapped to data fields in the digital data packages.

13. A method comprising:
receiving patient digital data of one or more selected patients from one or more medical practice electronic health records into a computer hardware circuit;
the computer hardware circuit combining the patient digital data with a template to form one or more digital data packages in which the patient digital data is mapped to data fields in the digital data packages in accordance with a structure and format defined by said template;
the hardware circuit causing the one or more digital data packages to be stored in a memory device.

14. The method of claim 13 wherein the patient digital data comprises one or more of blinded patient data and non-blinded patient data.

15. The method of claim 13 wherein the patient digital data comprises one or more of patient digital data patient age, height, weight, blood pressure, lipid profile, past medical history, symptoms, diagnostic procedure, diagnosis, treatment, prescription, intervention, and outcome of treatment.

16. The method of claim 15 wherein the patient digital data further comprises one or more of laboratory data, social and family history, education, risks, assessment and plan, and patient diary data.

17. The method of claim 13 wherein the templates map one or more of purchase and pricing specifications to data fields in the digital data packages.

18. The method of claim 13, wherein said computer hardware circuit is associated with a practice node.

19. The method of claim 13, wherein said computer hardware circuit is not associated with a practice node.
